(19) United States
(12) Patent Application Publication
(10) Pub. No.: US 2025/0024539 A1
(43) Pub. Date: Jan. 16, 2025

(54) WIFI-7 MLO-AWARE MULTICAST TO UNICAST OPTIMIZATION

(71) Applicant: HEWLETT PACKARD ENTERPRISE DEVELOPMENT LP, Spring, TX (US)

(72) Inventor: YANNICK KOEHLER, St. Laurent (CA)

(21) Appl. No.: 18/497,182

(22) Filed: Oct. 30, 2023

Related U.S. Application Data
(60) Provisional application No. 63/526,268, filed on Jul. 12, 2023.

(51) Int. Cl. H04W 76/15; H04W 72/51

(52) U.S. Cl. CPC H04W 76/15; H04W 72/51; H04W 84/12

(57) ABSTRACT

Systems and methods are provided for multicast to unicast optimization in WiFi-7 using Multi-Link Operation (MLO). The disclosed technology in examples provides mechanisms for improved transmission of data packets from a network device or Access Point (AP) to one or more subscribed clients or stations (STAs).

### CROSS REFERENCE TO RELATED APPLICATIONS

This application claims the benefit of and priority to U.S. Provisional Patent Application No. 63/526,268, filed on Jul. 12, 2023, the contents of which are incorporated herein by reference in their entirety.

### BACKGROUND

The seven-layer Open Systems Interconnection (OSI) model of computer networking includes the physical layer, the data link layer, the network layer, the transport layer, the session layer, the presentation layer, and the application layer. The physical layer is the first and lowest layer, and is the layer most closely associated with the physical connection between devices. The physical layer provides an electrical, mechanical, and procedural interface to the transmission medium. The shapes and properties of the electrical connectors, the frequencies to broadcast on, the line code to use, and similar low-level parameters are specified by the physical layer.

The data link layer is the second layer and is the protocol layer that transfers data between nodes on a network segment across the physical layer. The data link layer provides the functional and procedural means to transfer data between network entities and may also provide the means to detect and possibly correct errors that can occur in the physical layer. The data link layer is concerned with local delivery of frames between nodes on the same level of the network.

The Medium Access Control (MAC) sublayer is the layer that controls the hardware responsible for interaction with the wired, optical, or wireless transmission medium. The MAC sublayer and the Logical Link Control (LLC) sublayer together make up the data link layer. The LLC provides flow control and multiplexing for the logical link, while the MAC provides flow control and multiplexing for the transmission medium. When sending data to another device on the network, the MAC sublayer encapsulates higher-level frames into frames appropriate for the transmission medium (i.e. the MAC adds a sync word preamble and also padding if necessary), adds a frame check sequence to identify transmission errors, and then forwards the data to the physical layer as soon as the appropriate channel access method permits. When receiving data from the physical layer, the MAC block ensures data integrity by verifying the sender's frame check sequences, and strips off the sender's preamble and padding before passing the data up to the higher layers. Accordingly, the MAC layer can request services from the physical layer in a single network device.

The Institute of Electrical and Electronics Engineers (IEEE) 802.11 communication standards—more commonly referred to as Wi-Fi—specify a set of Medium Access Control (MAC) and physical layer (PHY) protocols for implementing wireless local area network (WLAN) computer communication. The IEEE 802.11 protocol denotes a set of interface standards developed by the IEEE 802.11 committee for short-range communications. For example, the devices that implement the IEEE 802.11 protocol may have both 2.4 GHz and 5 GHz radios for transmitting and receiving data and management frames between devices with similar radio configurations.

IEEE 802.11 is a set of IEEE standards that govern wireless networking transmission methods. They are commonly used today in their 802.11a, 802.11b, 802.11g, 802.11n, and 802.11ac versions to provide wireless connectivity in the home, office, and some commercial establishments.

IEEE 802.3 is a working group and a collection standards defining the physical layer and data link layer's MAC of wired Ethernet. This is generally a local area network (LAN) technology with some wide area network (WAN) applications.

Wi-Fi 7 (IEEE 802.11be) is the successor to Wi-Fi 6/6E (IEEE 802.11ax) and promises to significantly boost the speed and stability of wireless connections while offering lower latency and the ability to seamlessly manage more connections than prior.

MLO (Multi-Link Operation) is a significant MAC feature introduced in Wi-Fi 7. MLO enables devices to simultaneously send and receive data across different frequency bands and channels, such as a 2.4 GHz band, a 5 GHz band, and a 6 GHz band. More specifically, MLO is a particular feature of the IEEE 802.11 be Extremely High Throughput (EHT) Wi-Fi 7 standard that allows network devices, like APs and client devices, the ability to transmit and receive data from the same traffic flow over multiple radio channels. For example, a first network device (e.g., the AP) may implement multiple radios, like a 2.4 GHz radio and 5 GHz radio, and each of these radios may communicate with a similar or overlapping frequency radios on a second network device (e.g., the client device). Accordingly, multi-link devices (MLDs) may communicate with one another using multiple links (e.g., 2.4 GHz, 5 GHz, 6 GHz).

However, various challenges are presented in transmitting data packets from an Access Point (AP) to subscribed clients or stations (STAs).

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates one example of a network configuration that may be implemented for an organization, such as a business, educational institution, governmental entity, healthcare facility or other organization.

FIG. 2 illustrates an example multi-link device (MLD) communication.

FIG. 3 shows a network device or AP communicating with at least one station according to an example of the present disclosure.

FIGS. 4A and 4B show a method for transmitting packets from a network device or AP to at least one station among a plurality of subscribing stations, according to an example of the present disclosure.

FIG. 5 is an example computing component that may be used to implement various features of transmitting a group of packets from a network device or AP to at least one station among a plurality of subscribing stations, according to an example of the present disclosure.

FIG. 6 depicts a block diagram of an example computer system in which various of the embodiments described herein may be implemented.

The figures are not exhaustive and do not limit the present disclosure to the precise form disclosed.

### DETAILED DESCRIPTION

Examples of the present disclosure provide systems and methods for multicast to unicast optimization in WiFi-7 using Multi-Link Operation (MLO). The disclosed technology in examples provides mechanisms for improved transmission of data packets from an Access Point (AP) to one or more subscribed clients or stations (STAs).

In computer networking, unicast is a one-to-one transmission from one point in the network to another point; that is, one sender and one receiver, each identified by a network address. Internet Protocol unicast delivery methods such as Transmission Control Protocol (TCP) and User Datagram Protocol (UDP) are typically used. Unicast is in contrast to multicast which is a group communication in which data transmission is addressed to a group of destination clients simultaneously. Multicast transmission can be a one-to-many or a many-to-many distribution. In one conventional example multicast transmission is a one-to-many distribution in which an Access Point (AP) forwards all data packets from a multicast server source to a client subnet where multiple client devices are listening. The multicast server sends out a single stream during the transmission, allowing multiple clients to listen in. The multicast source relies on multicast-enabled routers to forward the data packets to all client subnets that have clients listening.

In another conventional example network configuration and methodology, an Access Point (AP) sends data packets to clients or stations (STAs) that belong to a group of subscribers associated to the AP. This data comes from the internet or is generated at the AP. When a STA subscribes to multicast, the AP converts a multicast frame to a unicast frame so that the data is sent only to the STA that needs it. This is referred to as Dynamic Multicast Optimization (DMO).

The conversion from multicast to unicast also provides a specific Wi-Fi optimization which is that within a given channel there are multiple speeds at which a frame can be transmitted. In some examples, in order to support older STAs using older IEEE 802.11 specifications, multicast management frames must be transmitted at a slower speed in order to reach all of the STAs (both old and new STAs). Converting multicast frames to unicast can then allow the AP to transmit those frames at the fastest speed supported by the STA at the other end, which is often much higher than the group (multicast/broadcast) speed. As such, even though there are more frames to transmit, due to the speed increase possibility, it may still take less “total” air time to transmit all the unicast frames than to transmit a single multicast frame, depending on the number of STAs and at which speed they can receive.

In the context of Wi-Fi 7 which provides Multi-Link Operation (MLO) support, a given STA may be able to receive (packets or data) on more than one band. If nothing is done specifically for this at the AP, then in a situation in which more than one STA is subscribed to in the same multicast group, the AP may convert the multicast frame into multiple unicast frames and send the converted unicast frames over the same band for each STA or to a band selected by the MLO algorithm, which may not be efficient if other STA links aren't taken into consideration.

Technical improvements are realized throughout the present disclosure. In one example, the present disclosure provides a method for the AP to consider, for each STA subscribed to a given multicast group, the STA's MLO capability and its band usage in order to determine which band each STA can receive over, and then distribute the unicast frames for the many STAs across bands in order to maximize the simultaneous transmission over multiple bands of the unicast frame for each STA involved. Some STAs in the group are MLO-aware and therefore can receive packets on multiple bands at the same time (e.g., on both 5 GHz and 6 GHz bands). Other STAs in the group are not MLO-aware and therefore can only receive on a single band (e.g., 6 GHz). An AP according to an example of the present disclosure is able to (a) determine which STAs are MLO-capable and which STAs are not, (b) transmit packets over a single band (e.g., 6 GHz) for STAs that are not MLO-aware, and (c) transmit packets across multiple bands for STAs that are MLO-aware. In this way, available bands of STAs with MLO-capability are not going unused, and the AP operation and methodology is designed to optimize packet transmission to the STAs based on the available bands to transmit over. This can enable the AP to answer a STA faster and take less air time for such functionality. Moreover, packets can leave the AP's queue faster. Such advantages can be increasingly beneficial as the number of packets to be transmitted increases.

As another example of the present disclosure, take STA1 and STA2 associated to an AP where STA1 is MLO-aware and can receive on the 5 Ghz and 6 Ghz bands at the same time, whereas STA2 is not MLO-aware and is connected only to the 6 Ghz band. On the reception of a multicast frame, the AP would then identify STA1 and STA2 as being subscribed to this group and would consider that STA1 can receive on both the 5 GHz and 6 Ghz bands at the same time whereas STA2 can only receive on 6 Ghz; thus the AP would transmit the STA1's unicast frame over 5 GHz while at the same time transmitting the STA2's unicast frame over 6 Ghz. Without this logic, the AP may decide to send both unicast frames on the 6 Ghz band and therefore delay the reception of the second unicast frame; meanwhile, the 5 GHz band would potentially go unused.

In conventional methods, packets get assigned by the initial association band or by highest band speed. In contrast, with MLO-based distribution components of examples of the present disclosure, the distribution can take into account the overall transmission time for each band, so as to reduce the total time of work across all bands together, which can result in the capacity to transmit the same number of packets at significantly or even substantially reduced time depending on a given scenario. By virtue of the features of the present disclosure, AP transmission can be optimized, and transmission time minimized.

Another example of the present disclosure is a method which, as an initial step, determines single band or single receiver STAs. This can be done using an association table stored in the AP, although the present disclosure is not limited to this example. Next, the method distributes the packets to the single band STAs first. The method then distributes the packets to MLO-capable STAs, optimizing the packet distribution by considering (a) available bands, (b) packets on each available band, and (c) weighting.

With regard to weighting, the 2.4 GHz band is slower than the 5 GHz band which is slower than the 6 GHz band (though the jump from 5 GHz to 6 GHz is smaller than the jump from 2.4 GHz to 5 GHz). The method considers a weighted distribution per band. For example, assume that there are 50 packets to be distributed over three bands (2.4 GHz, 5 GHz, 6 GHz). In one example the 50 packets may be distributed as 10-20-20 packets over 2.4 GHz-5 GHz-6 GHz respectively, which is 20%-40%-40% by weight distribution per band. Weight is calculated from historical data so the distribution by weight may not be perfect or even optimal. The method therefore adjusts further to optimize the distribution using factors at the AP/STA such as signal-to-noise ratio (SNR), channel width (i.e., how many channels can be used to transmit), and band. The goal is to optimize AP transmission and packet distribution taking into account STA capability (e.g., MLO) and available bands. The method selects which band to use per receiver, to thereby reduce the total transmission time and reduce the number of packets in the queue/move them out of the queue faster.

It is noted that currently, Wi-Fi 7 is designed to offer communication over three bands (2.4 GHz, 5 GHz, 6 GHz). However the present disclosure is not limited to only three bands, as more bands could be added in the future. Furthermore, in a scenario in which multi-link capability supports WiFi+5G connectivity, or any other type of connectivity, the disclosed technology can apply to those as well. In such scenarios, the link of those technologies is simply another link to consider with potentially a different weight/cost. As one non-limiting example, Integrated Services Digital Network (ISDN) also has multi-link support over multiple channels of different speeds, a scenario for which the disclosed technology can be beneficial as well. The disclosed technology can also be applicable to technology using links formed at a higher level; for example, an AP could have two uplinks, one using cell and one using ethernet or a virtual private network (VPN). Of course, these are just examples, and the present disclosure is not limited thereto.

The present disclosure according to one example provides a method performed by an Access Point (AP) for transmitting a group of packets from the AP to at least one station among a plurality of subscribing stations. The method includes, for each station associated with the group of packets, identifying which bands the station can receive on. The method includes determining which stations associated with the group of packets have only single-band capability and which stations have Multi-Link Operation (MLO) capability. For each station having only single-band capability, packets in the group are transmitted over a single band. For each station having MLO capability, the method includes: combining each of the two bands the station can receive on to generate dual band combinations, and calculating an ideal number of packets for each respective band. When an actual number of packets on a respective band is less than the ideal number of packets calculated for that respective band, the method calculates a number of missing packets from the ideal number of packets calculated for the respective band, and the missing packets are added to the respective band from one of the dual band combinations that includes the respective band. The packets in the group are transmitted over the respective bands simultaneously.

The ideal number of packets for each respective band may be based on at least one of band speed, channel width, channel availability, signal-to-noise ratio (SNR), or average speed on the channels. In one example, the multiple bands are 2.4 GHz, 5 GHz, and 6 GHz. Accordingly, there may be more than one “ideal” number of packets depending on the factors and methodology used to calculate it.

The present disclosure according to another example provides a method performed by an Access Point (AP) for transmitting a group of packets from the AP to at least one station among a plurality of subscribing stations. The method includes determining which stations have only single-band capability and which stations have Multi-Link Operation (MLO) capability. The method also includes transmitting, to each station having only single-band capability, packets in the group over a single band. The method also includes transmitting, to each station that has MLO capability, the packets in the group over multiple bands by: calculating an ideal number of packets for each respective band; when an actual number of packets on a respective band is less than the ideal number of packets calculated for the respective band, re-distributing the number of packets in each band so that the number of packets in each band corresponds to the ideal number of packets in the respective band; and transmitting the packets in the group over the respective bands simultaneously.

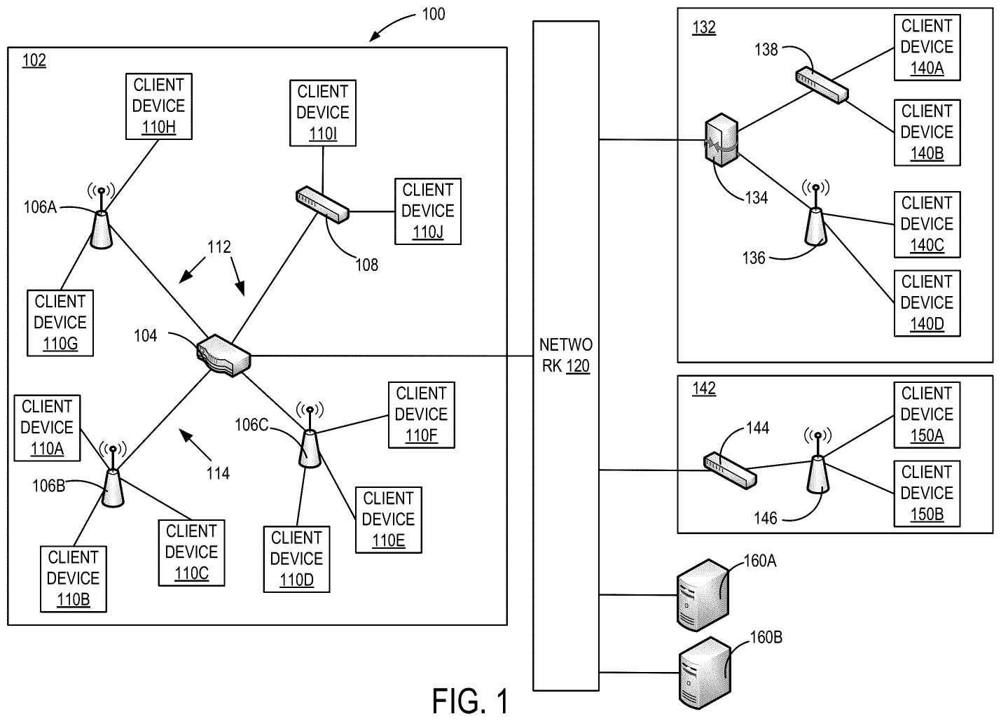

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, the primary site 102 includes a controller 104, which is in communication with the network 120. The controller 104 may provide communication with the network 120 for the primary site 102. There may be other points of communication with the network 120 for the primary site 102 in addition to controller 104. Although single controller 104 is illustrated, the primary site 102 may include multiple controllers and/or multiple communication points with network 120, any combination of which may be MLDs. In some embodiments, the controller 104 may communicate with the network 120 through a router, which may also be an MLD capable of multi-link tunnel communications that are compliant with the IEEE 802.11 standard. In other embodiments, the controller 104 provides router functionality to the devices in the primary site 102. In this specification, the word “tunnel” refers to an encapsulated mode of transporting data between AP and controller.

The controller 104 may be operable to configure and manage network devices, such as at the primary site 102, and may also manage network devices at the remote sites 132, 134. The controller 104 may be operable to configure and/or manage switches, routers, access points, and/or client devices connected to a network. The controller 104 may itself be, or provide the functionality of, an Access Point (AP). The controller 104 may be or include an MLD, which may be capable of multi-link tunnel communications compliant with the IEEE 802.11 standard.

The controller 104 may be in communication with one or more switches 108 and/or wireless Access Points (APs) 106a-c. Wireless APs 106a-c and switches 108 may also be an MLD that is capable of multi-link tunnel communications are compliant with the IEEE 802.11 standard. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired or wireless 112 connection. In the illustrated example, the switch 108 communicates with the controller 104 over a wired or wireless 112 connection.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be a satellite office, another floor or suite in a building, for example. The remote site 132 may include a gateway device 134 for communicating with the network 120. A gateway device 134 may be a router, a digital-to-analog modem, a cable modem, a digital subscriber line (DSL) modem, or some other network device configured to communicate with the network 120. The remote site 132 may also include a switch 138 and/or AP 136 in communication with the gateway device 134 over either wired or wireless connections. The switch 138 and AP 136 provide connectivity to the network for various client devices 140a-d. Gateway device 134, AP 136, and switch 138, may be MLDs that are capable of multi-link tunnel communications compliant with the IEEE 802.11 standard.

In various embodiments, the remote site 132 may be in direct communication with primary site 102, such that client devices 140a-d at the remote site 132 access the network resources at the primary site 102 as if these client devices 140a-d were located at the primary site 102. In such embodiments, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various embodiments, the network configuration 100 may include one or more smaller remote sites 142, comprising only a gateway device 144 for communicating with the network 120 and a wireless AP 146, by which various client devices 150a-b access the network 120. The gateway device 144 and the wireless AP 146 may be MLDs that are cable of multi-link tunnel communications compliant with the IEEE 802.11 standard. Such a remote site 142 may represent, for example, an individual employee's home or a temporary remote office. The remote site 142 may also be in communication with the primary site 102, such that the client devices 150a-b at the remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers 160a-b. The content servers 160a-b may include various providers of multimedia downloadable and/or streaming content, including audio, video, graphical, and/or text content, or any combination thereof. Examples of content servers 160a-b include web servers, streaming radio and video providers, and cable and satellite television providers. The client devices 110a j, 140a-d, 150a-b may request and access the multimedia content provided by the content servers 160a-b. The content servers 160a-b may be MLDs that are cable of multi-link tunnel communications compliant with the IEEE 802.11 standard. The portions of network 120 and/or the individual sites 102, 132, 142, may utilize dynamic frequency selection (DFS) channels for communication. As an example, communication over a secure tunnel may exist between controller 104 and AP 106a-c. Having multi-link communications increase the throughput.

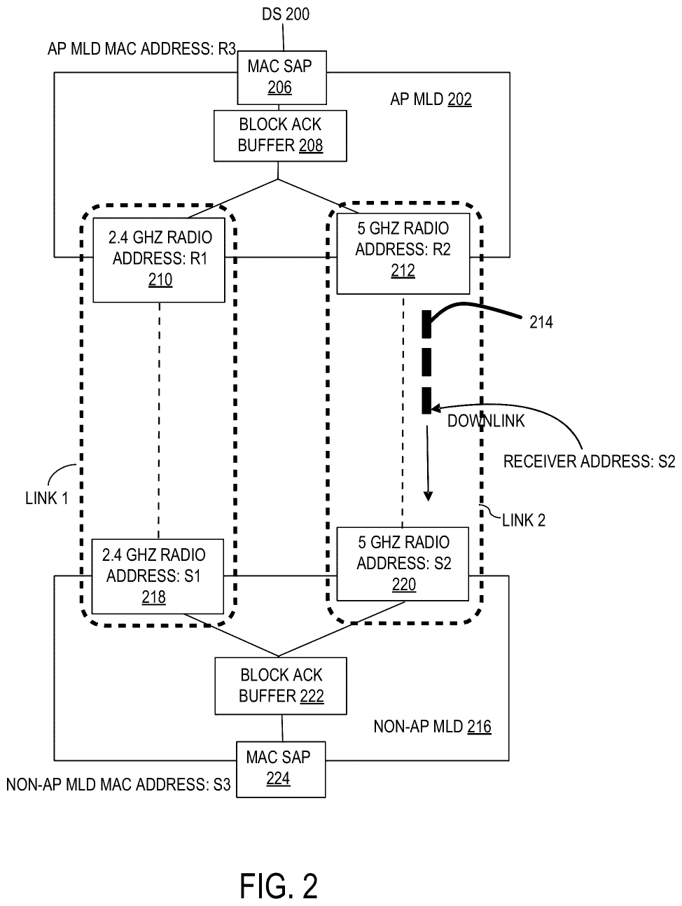

FIG. 2 illustrates an MLD communication 200. In FIG. 2 a message comes from a distribution system (DS) 200, such as a network, to an access point, AP MLD 202. In FIG. 2, a message from DS arrives at AP MLD 202, via media access control layer—service access point (MAC-SAP) 206 and waits in a queue in block ack (BA) buffer 208 to be sent to Non-AP MLD 216. The message is sent via either Link 1 or Link 2. During multi-link operations (MLO), multiple 802.11 devices with multiple radios may operate simultaneously on multiple channels, which may carry multiple frequencies (e.g., 2.4 GHz, 5 GHz, 6 GHz or other frequencies). Frames from a single traffic session can be sent on multiple links using the first available link (Link 1 or Link 2). Each link may be a unique wireless channel (as defined in the 802.11 standard). If the message is sent via Link 1, the message is sent from address R1 across interface 210 to address S1 across interface 218. If the message (e.g., frame 214) is sent via Link 2, the message travels from address R2 across interface 212 to address S2 across interface 220. Whether the message arrives via interface 218 or 220, the message waits in a queue at BA buffer 222, to be sent to DS, via MAC SAP 224. MLO allows a non-AP MLD 216 to send/receive data to/from AP MLD 202 over multiple links (Link 1 and Link 2). In the example of FIG. 2, a non-AP MLD 216 is associated with AP MLD 202 that is sending frames on the downlink (DL) on ‘Link 2’ in the 5 GHz frequency range.

The MAC SAP component 224, or Media Access Control (MAC) Service Access Point (SAP), may provide an interface for connecting the radios of network devices to a backend system. This interface functionality may include access to control and management functions as a physical or virtual controller of a network device and provide corresponding functionality. For example, the MAC SAP serves as a translator with the network devices and the lower layers of IEEE 802.11 (Wi-Fi) and IEEE 802.3 (Ethernet). MAC SAP component 224 may enable the functionality of an access point to give the network devices access to the wired network.

Sending data from a traffic session using the first available channel (selected from multiple channels) can improve throughput and reduce latency. The MLDs, AP MLD 202 and non-AP MLD 216, may be logical entities defined by the IEEE 802 family of standards to interface multiple MAC/physical layer (MAC/PHY) systems with each other. AP MLD 202 and non-AP MLD 216 may each have a single MAC-SAP (206 and 224) interface to the upper layers, so that the upper layers do not need information about the links on which the MLD is operating. Within the MLD, there may be one or more client devices where each client device may be a MAC-PHY instance operating on a link. To make the operation efficient, authentication may be performed by the MLDs so that the client devices do not need to establish connections separately on each link, and the MLDs can perform a single setup for multiple links.

A collection of frames 214, which may be sent on the downlink (DL), can just as well be sent fully on ‘Link 1’ or fully on ‘Link 2. Two frames can be transmitted, for example, on both links simultaneously using the two links, one frame per link. This is because both the non-AP MLD 202 and AP MLD 216 share the same buffer for the BA agreement for both the links. The BA agreement may specify the capability of the sender and receiver and the policy for sending messages. In other words, the common buffer for BA agreement allows frames 214 to be sent on either or both Links 1 and 2.

For the AP MLD 202, in addition to radio addresses R1 and R2, address R3 is defined which identifies the AP MLD entity. A similar address is defined for the non-AP MLD, which in this case is client device S3. The MLDs may be any device that has the capability to use the 802.11 be standard, such as a laptop computer, a desktop PC, PDA access point or Wi-Fi phone. The MLD may be fixed, mobile, or portable. The MLD may be a transmitter or receiver, and the MLD may include a media access control (MAC) and physical layer (PHY) interface to the wireless medium (WM).

Since the non-AP MLD 216 can send/receive frames over multiple links to/from an AP simultaneously, the throughput of the non-AP MLD 216 is higher than if were there only one link available. Also, since the non-AP MLD 216 can communicate using both Link 1 and Link 2 independently, the average channel access delay is reduced, thus improving latency.

There may exist a single association and a security context between a non-AP 216 MLD and AP MLD 202. Consequently, a single encryption key may be derived by both the MLDs to be used for encrypting/decrypting frames for both Links 1 and 2. Along with the common BA buffer 208 or 222, this allows the flexibility required to send frames over any link without much processing or queueing delay.

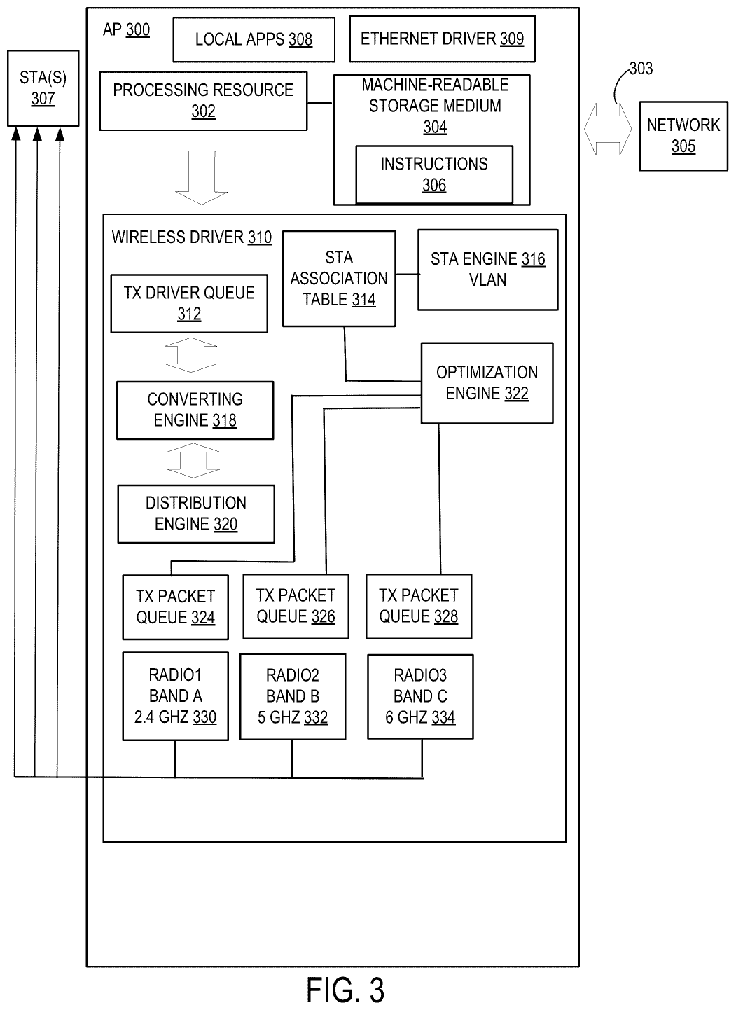

FIG. 3 shows a network device or AP 300 communicating with at least one station (STA) 307 according to an example of the present disclosure. The network device or AP 300 may be, for example, APs 106a-c, 136, 146 as shown in FIG. 1. The stations may be, for example, client devices 110a-j, 140a-d, 150a-b as shown in FIG. 1. Of course, these are just examples and the present disclosure is not limited thereto.

More specifically, FIG. 3 shows a system, architecture, or network device 300 according to an example of the present disclosure. The network device 300 may be for example, an AP W-Fi front end. The network device or AP 300 includes at least one processing resource 302 and at least one machine-readable medium 304 comprising (e.g., encoded with) at least instructions 306 that are executable by the at least one processing resource 302 of network device 300 to implement functionalities described herein in relation to instructions 306 or network device 300. In the example of FIG. 3, network device or AP 300 may engage in any network data transmission operations, including, but not limited to, switching, routing, bridging, or any combination thereof. In some examples, network device 300 may comprise a Wireless Access Point (WAP) or Access Point (AP). In examples described herein, a WAP generally refers to receiving points for any known or convenient wireless access technology which may later become known. Specifically, the term WAP is not intended to be limited to WAPs which conform to IEEE 802.11 standards. A WAP generally functions as an electronic device that is adapted to allow wireless devices to connect to a wired network via various communications standards. A WAP may include any necessary hardware components to perform the inventions disclosed herein, including, but not limited to: processors, memories, display devices, input devices, communications equipment, etc. It will be understood by one of ordinary skill in the art that network device or AP 300 may be any suitable type(s) of network devices made by any suitable manufacturer(s).

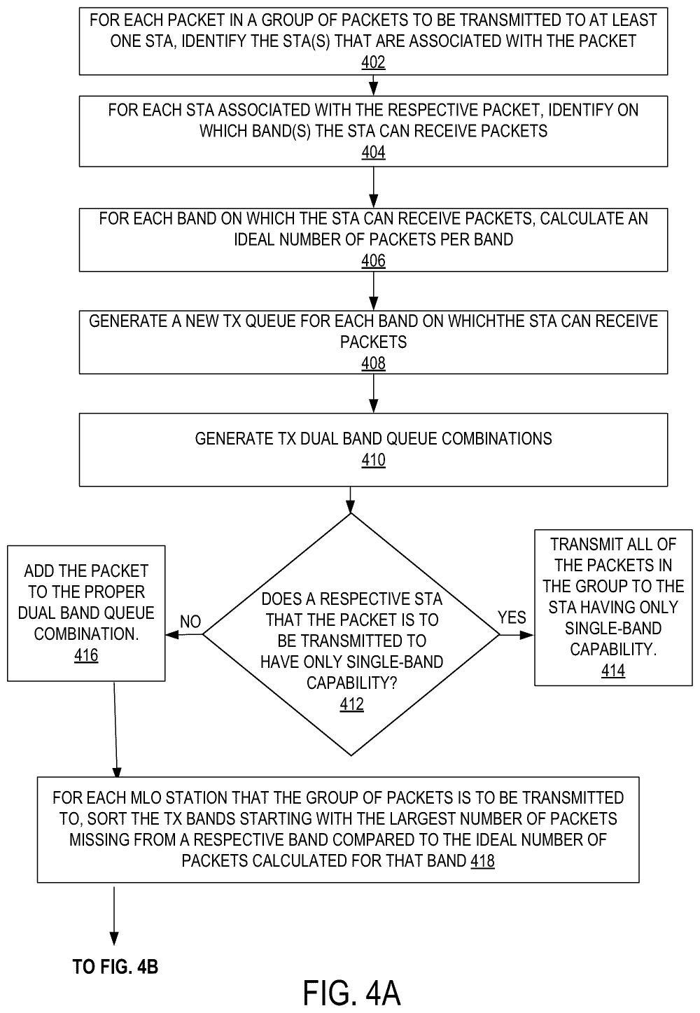

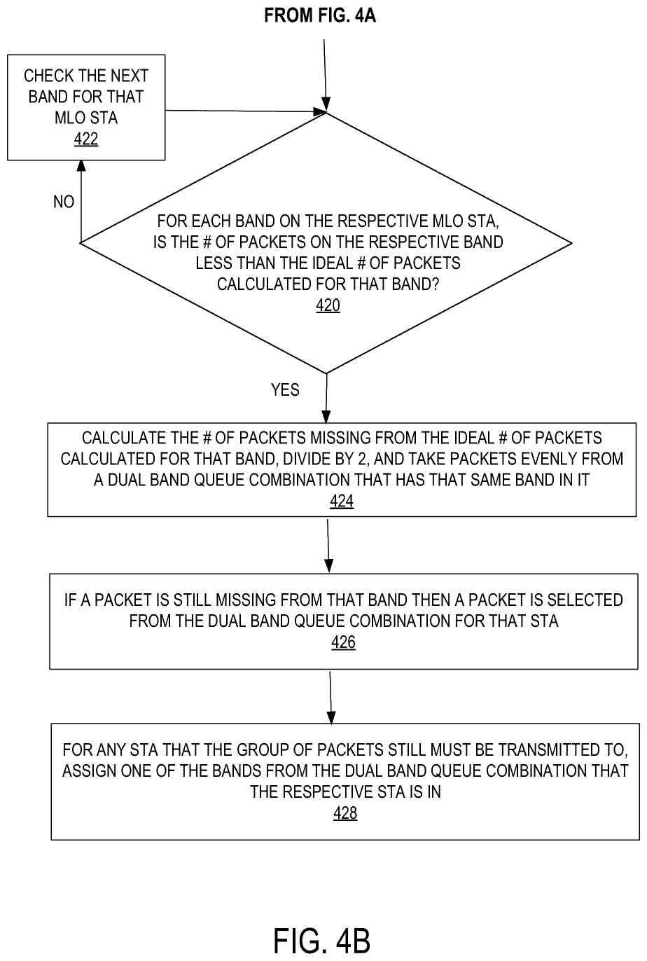

The AP 300 of FIG. 3 communicates with wireless driver 310 and at least one network 305 over the ethernet 303, and includes local applications 308 and ethernet driver 309. Processes performed by the AP 300 of FIG. 3 (e.g., instructions 306 for transmitting packets from an AP to at least one station among a plurality of subscribing stations according to an example of the present disclosure, will be described in more detail in connection with FIGS. 4A and 4B below).

The station engine 316 includes STA MAC 316a and stores information regarding MLO receiver capabilities and usable receive bands. As a starting point, there may be a group of packets in the transmission (TX) driver queue 312 for transmitting to at least one station among the plurality of subscribing stations 307.

For each packet in the TX driver queue 312, the station engine 316 captures a pointer to the packet to identify the station(s) associated with the packet, i.e., the station(s) that are to receive the packet, among the subscribing stations 307 associated with the packet. The station engine 316 removes the designation of which band the packet may have previously been assigned to.

In more detail, in one example of the present disclosure, the system has a queue which holds all of the packets to be transmitted. That queue may contain “packets” objects or some form of meta-packet structure. The disclosed technology in one example recreates that queue, potentially using a different order, yet does not copy the packet itself which may be several bytes. The disclosed technology therefore captures/copies the meta data into a new queue to enable the system to modify and then switch queues at the end, so that the new queues becomes the queue.

In some non-limiting examples of the present disclosure, the association between the packet/frame and the STA is done using meta-data stores in the packet structure, or from scanning the MAC address within the packet header. Preferably this is done using meta-data, as a MAC lookup may be of higher cost, yet that requires the engine to have preserve the association as meta-data in the TX queue.

In another example, the change to the queue may be done inline within the same queue. In some examples each radio would have its own TX queue, but there are cases in which multiple radios can share a single queue, or there are multiple TX queues for priority and such. Regardless, these are just examples, and the present disclosure is not limited thereto; the disclosed technology would still work independently of how the queue system is designed in the product (e.g., one queue global, one queue per radio, one queue per priority/global, one queue per priority/per radio, etc.).

The station association database or table 314 (which may be located in the AP 300 or external thereto) associates each station among the subscribing stations 307 to either single-band capability or MLO capability. For each station associated with the respective packet, the station engine 316 can identify, using the station association table 314, which band(s) the station can receive on. The converting engine 318 converts multicast/broadcast to unicast. In one example a packet is converted from multicast to unicast by creating a copy of the packet, altering the destination MAC address, and replacing the multicast address with the STA address. The multicast packet is then discarded when the operation is completed for all STA part of the multicast group. The association table 314 in one example provides a reference listing of band(s) and corresponding stations, such that the AP 300 can access the table and look up matching band(s), or band(s) to which stations are associated, and so on. It should be noted that in accordance with some examples, the STA (association table) entry corresponding to the created/converted unicast packet. When sending a multicast packet, the network from where it originated can be determined. The STAs that are operative on that same network can be identified, as well as the band with which those STAs are associated. Accordingly, the multicast packet that be transmitted on those bands where the STAs were identified. In contrast, when a multicast packet is converted to a unicast packet, in addition to the above-mentioned operations (i.e., instead of just identifying whether or not “at least” one STA exists on a given band, the packet's metadata may be copied, and the STA's band association can also be recorded as part of the packet's metadata (as well as a destination MAC address).

For each band on which the respective station can receive transmissions/communications, the distribution engine 320 calculates an ideal distribution value (e.g., an ideal percentage of packet distribution per band or an ideal number of packets per band) based on the band's pre-calculated weight value. This can be done based on historical data or characteristics of the band such as band speed, channel width, signal-to-noise ratio (SNR), the average speed on the channels, etc.

Accordingly, there may be more than one “ideal” number of packets depending on the factors and methodology used to calculate the ideal number. Moreover, as a person having ordinary skill in the art reading this document will recognize, a true or perfect “ideal” number cannot always be achieved; accordingly, an “ideal” number can include a number that is as good or effective as possible or practical under the given circumstances. Further to these points, in some examples there may be multiple or even many factors that can change the “ideal” distribution. For example, one can imagine a situation in which one of the links carries a significant cost in money; one may then want an “ideal” distribution to put less weight on this link so that others get used first. Accordingly, the weight here can play a role in defining what “ideal” is being sought. The algorithm can try to match this ideal but may not be capable of fully honoring it, for example if not enough STA packets are at the queue at this particular moment. As another example, assume one wants a 25%/25%/50% distribution and one has 1 multicast frame converted to 2 unicast frames. One will then likely reach a distribution value different from 25/25/50.

The distribution engine 320 generates a new/empty transmission queue for each band on which the station can receive, e.g., TX packet queues 324, 326, and 328. The TX packet queues 324, 326, and 328 communicate with the station(s) among the subscribing stations 307 via radio1 330, radio2 332, and radio3 334 respectively. Radio1 corresponds to Band A and may be, e.g., 2.4 GHz. Radio2 corresponds to Band B and may be, e.g., 5 GHZ. Radio3 corresponds to Band C and may be, e.g., 6 GHz. Again, it is noted that while currently Wi-Fi 7 is designed to offer communication over three bands (2.4 GHz, 5 GHz, 6 GHz), the disclosed technology is not limited to being used with only three bands, as more bands could be added in the future.

The optimization engine 322 identifies/generates TX dual band queue combinations based on combinations of bands, e.g., 2.4 GHz+5 GHz, 2.4 GHz+6 GHz, 5 GHz+6 GHz. In general the optimization engine 322 determines an MLO-specific distribution of respective bands based on reception capabilities and band weight (calculated from factors such as speed, channel, width, etc.). The optimization engine 322 performs initial reshuffling of queues and is triggered on a threshold or on a multicast to unicast event.

More specifically, the optimization engine 322 performs optimization as follows for each packet in the TX driver queue 312 according to an example of the present disclosure. First, it is determined whether a respective station that the packet is to be transmitted to has only single-band capability (i.e., can only receive on a single band) or has MLO capability (i.e., can receive on multiple bands). If a respective station to which the packet is to be transmitted can only receive in a single band, then the packet is placed in the associated single band right away (all packets in the group are transmitted to the station having only single-band capability), and the respective station is marked as having been handled. Such marking can be performed, for example, by a flag, although the present disclosure is not limited to this method of marking. With the idea of “re-creating” a new queue as indicated above, “handled” according to examples suggests that the system is done with this packet and can process the next one to be processed. Since the algorithm is not “single-pass” in this example, we expect to go again through the initial queue to handle any packets that were not handled/done. One reason is to ensure that no frames in the initial queue are left out. That is, one reason for tracking which packet(s) has been handled is because the disclosed processing is performed with an aim towards reaching an “ideal” distribution. That said, non-ideal cases typically arise, e.g., if there are four unicast packets on a 2.4 GHz band, two unicast packets on a 5 GHz band, and one unicast packet on a 6 GHz band, the desire is to have one unicast packet per band (represented as “1/1/1” in this example). Accordingly, the algorithm can manage the 1/1/1 packets, and then determine if any packet(s) have been left over/remain. If so, those remaining packets can be added back to ultimately produce a “1/2/1” distribution. Without the algorithm operating in such a manner, any packet outside of a computed Ideal distribution, where the computed ideal distribution is determined first.

If on the other hand a respective station that the packet is to be transmitted to can receive on two or more bands, then the packet is added to a proper dual band queue combination; that is, the packet(s) are added to the dual band queue combinations previously generated. For example, if there are three bands available, 2.4 GHz, 5 GHz, and 6 GHz, then the dual band queue combinations are 2.4 GHz+5 GHz, 2.4 GHz+6 GHz, and 5 GHz+6 GHz).

For each station with MLO capability that the group of packets is to be transmitted to, the optimization engine 322 sorts the transmission bands for that station starting with the largest number of packets that are “missing” from a respective band compared to the ideal number of packets calculated for that band.

For each transmission band on a station having MLO capability that the group of packets is to be transmitted to, the optimization engine 322 checks whether the packet distribution (number of packets) on the respective band for that station is less than the ideal distribution (number of packets) calculated for that band. Thus, it is determined whether the packet distribution (number of packets) on a respective band for a respective station among the plurality of subscribing stations 307 is less than the ideal distribution (number of packets) calculated for that band. If the outcome of that determination is NO (the packet distribution on the respective band is not less than the ideal distribution calculated for that band) then the optimization engine 322 proceeds to check the next band for that station (i.e., check whether the number of packets in the next band is less than the ideal number of packets calculated for that band). If the outcome of that determination is YES (the packet distribution on the respective band is less than the ideal distribution calculated for that band), then the optimization engine 322 calculates the number of packets “missing” from the ideal number of packets calculated for that band (i.e., the number of packets below the ideal number), divides by two, and takes packets evenly from a dual band queue combination that has that same band in it. For example, a 2.4 GHz band can take from the group 2.4 GHz+5 GHz or from the group 2.4 GHz+6 GHz; a 5 GHz band can take from the group 2.4 GHz+5 GHz or from the group 5 GHz+6 GHz; a 6 GHz band can take from the group 2.4 GHz+6 GHz or from the group 5 GHz+6 GHz).

If a packet is still missing from that band after the above operation has been performed, then a packet is selected from the dual band queue combination for that station. For each station that the group of packets are transmitted to, the station is marked as handled via a flag or other method. A count is kept of how many stations are left, i.e., how many stations remain that the group of packets must still be transmitted to.

For any stations that are left, the optimization engine 322 navigates them and assigns one of the bands from the dual band queue combination that the respective station is in. The actual choice is not critical or that important; the highest can be selected, or a random one, or a primary one, etc.

As alluded to above, FIGS. 4A and 4B illustrate a method 400 for transmitting packets from an AP, e.g., the AP 300, to at least one station among a plurality of subscribing stations, e.g., stations 307, according to an example of the present disclosure (although the method 400 can begin with just one packet).

According to one example, the method 400 can operate in conjunction with a network device or AP such as network device or AP 300 communicating with at least one station (STA) among one or more subscribing stations, e.g., stations 307. In such example, the AP 300 can perform steps of the method 400 from instructions 306. The network device or AP 300 may be, for example, APs 106a-c, 136, 146 as shown in FIG. 1. The stations may be, for example, client devices 110a-j, 140a-d, 150a-b as shown in FIG. 1. Of course, these are just examples and the present disclosure is not limited thereto.

Step 402 includes identifying, for each packet in a group of packets to be transmitted to at least one station, the station(s) that are associated with the respective packet. For example, a pointer to the packet may be captured to identify the station(s) associated with the packet, i.e., the station(s) that are to receive the packet. The designation of which band the packet may have previously been assigned to is removed. Each station among the subscribing stations is associated to either single-band capability or MLO capability. This can be done, for example, using a station association database or table (such as station association table 314, which may be located in the AP or external thereto) that associates each station to either single-band capability or MLO capability.

Step 404 includes identifying, for each station associated with the respective packet, on which band(s) the station can receive packets/data. This step can be performed using, e.g., a station association table, such as station association table 314. As one example, the station association table provides a reference listing of band(s) and corresponding stations, such that the AP can access the table and look up matching band(s), or band(s) to which stations are associated, and so on.

Step 406 includes calculating, for each band on which the station can receive transmissions/communications, an ideal distribution value (e.g., an ideal percentage of packet distribution per band or an ideal number of packets per band) based on the band's pre-calculated weight value. This can be done based on historical data or characteristics of the band such as band speed, channel width, signal-to-noise ratio (SNR), the average speed on the channels, etc.

As noted above, there may be more than one “ideal” number of packets depending on the factors and methodology used to calculate the ideal number. Moreover, as a person having ordinary skill in the art reading this document will recognize, a true or perfect “ideal” number cannot always be achieved; accordingly, an “ideal” number can include a number that is as good or effective as possible or practical under the given circumstances.

Step 408 includes generating a new/empty transmission queue for each band on which the station can receive. An example of this is shown in FIG. 3, in which TX packet queues 324, 326, and 328 communicate with the station(s) via radio1 330, radio2 332, and radio3 334 respectively. Radio1 corresponds to Band A and may be, e.g., 2.4 GHz. Radio2 corresponds to Band B and may be, e.g., 5 GHZ. Radio3 corresponds to Band C and may be, e.g., 6 GHz. Again, it is noted that while currently, Wi-Fi 7 is designed to offer communication over three bands (2.4 GHz, 5 GHz, 6 GHz), the disclosed technology is not limited to being used with only three bands, as more bands could be added in the future.

Step 410 includes generating TX dual band queue combinations based on combinations of bands, e.g., 2.4 GHz+5 GHz, 2.4 GHz+6 GHz, 5 GHz+6 GHz. An MLO-specific distribution of respective bands can be generated based on reception capabilities and band weight (calculated from factors such as speed, channel, width, etc.). More specifically, optimization can be performed as follows for each packet in a TX driver queue.

First, in step 412, it is determined whether a respective station that the packet is to be transmitted to has only single-band capability (i.e., can only receive on a single band) or has MLO capability (i.e., can receive on multiple bands). If a station to which the packet is to be transmitted can only receive in a single band (YES to step 412), then in step 414 the packet is placed in the associated single band right away (all packets in the group are transmitted to the station having only single-band capability), and the respective station 307 is marked as having been handled. Such marking can be done, for example, by a flag, although the present disclosure is not limited to this method of marking.

If on the other hand a station that the packet is to be transmitted to can receive packets on two or more bands (NO to step 412), then in step 416 the packet is added to a proper dual band queue combination; that is, the packet(s) are added to the dual band queue combinations previously generated in step 410. For example, if there are three bands available, 2.4 GHz, 5 GHz, and 6 GHz, then the dual band queue combinations are 2.4 GHz+5 GHz, 2.4 GHz+6 GHz, and 5 GHz+6 GHz).

Step 418 includes, for each station with MLO capability that the group of packets is to be transmitted to, sorting the transmission bands for that station starting with the largest number of packets that are “missing” from a respective band compared to the ideal number of packets calculated for that band. In step 420, for each transmission band on a station having MLO capability that the group of packets is to be transmitted to, it is checked whether the packet distribution (number of packets) on the respective band for that station 307 is less than the ideal distribution (number of packets) calculated for that band; thus, in step 420 it is determined whether the packet distribution (number of packets) on a respective band for a respective station 307 is less than the ideal distribution (number of packets) calculated for that band.

If the outcome of step 420 is NO (the packet distribution on the respective band is not less than the ideal distribution calculated for that band) then step 422 proceeds to check the next band for that station (i.e., check whether the number of packets in the next band is less than the ideal number of packets calculated for that band). If the outcome of step 420 is YES (the packet distribution on the respective band is less than the ideal distribution calculated for that band), then the method proceeds to step 424. Step 424 calculates the number of packets “missing” from the ideal number of packets calculated for that band (i.e., the number of packets below the ideal number), divides by two, and takes packets evenly from a dual band queue combination that has that same band in it. For example, a 2.4 GHz band can take from the group 2.4 GHz+5 GHz or from the group 2.4 GHz+6 GHz; a 5 GHz band can take from the group 2.4 GHz+5 GHz or from the group 5 GHz+6 GHz; a 6 GHz band can take from the group 2.4 GHz+6 GHz or from the group 5 GHz+6 GHz).

In step 426, if a packet is still missing from that band after step 424 has been performed, then a packet is selected from the dual band queue combination for that station. For each station that the group of packets are transmitted to, the station is marked as handled via a flag or other method. A count is kept of how many stations are left, i.e., how many stations remain that the group of packets must still be transmitted to.

Step 428 includes, for any STA that are left (i.e., that the group of packets still must be transmitted to), assigning one of the bands from the dual band queue combination that the respective station is in. The actual choice is not necessarily a critical choice to make, as various bands can be selected to achieve the desired transmission, e.g., the highest can be selected, a random band can be selected, a primary band can be selected, etc.

An example run according to the method of the present disclosure shown in FIGS. 4A and 4B is as follows. The method in this example can be performed by AP 300. Of course, the present disclosure is not limited to this example.

This example run carries the following pre-conditions. There are 50 packets in the TX driver queue 316. There is a pre-calculated weight value of 2.4 GHz (20%); 5 GHz (40%); and 6 GHz (40%). The single band STA has: 2.4 GHz: 9 packets; 5 GHz: 7 packets; 6 GHz: 8 packets. The dual band STA has: 2.4 GHz+5 GHz: 7 packets; 2.4 GHz+6 GHz: 13 packets; and 5 GHz+6 GHz: 6 packets.

As noted above, step 402 includes, for each packet in a group of packets to be transmitted to at least one station among the subscriber stations 307, identifying the station(s) that are associated with the packet. For each packet in the TX driver queue 312, a pointer to the packet is captured to identify the station(s) associated with the packet, i.e., the station(s) that are to receive the packet. The designation of which band the packet may have previously been assigned to is removed. Accordingly, a queue of the 50 packets is built, with a pointer for each packet to identify the station(s) associated with the packet.

Step 404 includes, for each station associated with the respective packet, identifying which band(s) the station(s) can receive on. This can be done using the station association table 314. The STA-associated information is added to the packets in the TX driver queue 312. As one example, the station association table 314 provides a reference listing of band(s) and corresponding stations, such that the AP can access the table and look up matching band(s), or band(s) to which stations are associated, and so on.

Step 406 includes, for each band on which the station 307 can receive packets, calculating an ideal number of packets per band (e.g., an ideal percentage of packet distribution per band) based on weight as 2.4 GHz=10 (20% of 50 packets); 5 GHz=20 (40% of 50 packets); and 6 GHz=20 (40% of 50 packets). This can be done from historical data or band characteristics such as band speed, channel width, SNR, average speed on those channels, etc.

Step 408 includes generating a new/empty TX queue for each band on which the station 307 can receive packets, e.g., TX packet queues 324, 326, and 328.

Step 410 includes identifying/generating TX dual band queue combinations based on combinations of bands, e.g., 2.4 GHz+5 GHz, 2.4 GHz+6 GHz, and 5 GHz+6 GHz. Accordingly, in this example, three dual TX queue groups are generated based on possible combinations.

In step 412 it is determined whether a respective station that the packet is to be transmitted to has only single-band capability. If the outcome of step 412 is YES, then in step 414, all of the packets in the group are transmitted to the station 307 having only single-band capability.

If the outcome of step 412 is NO, then in step 416, the packet(s) are added to the proper dual band queue combination. Thus in this example, for every 50 packets in the TX driver queue 312, the following packets are processed and marked as handled: 2.4 GHz: 9 packets; 5 GHz: 7 packets; and 6 GHz: 8 packets. Further, dual band queue combinations previously generated in step 410 are added as: 2.4 GHz+5 GHz: 7 packets; 2.4 GHz+6 GHz: 13 packets; and 5 GHz+6 GHz: 6 packets.

Step 418 includes, for each MLO station that the group of packets is to be transmitted to, sorting the TX bands starting with the largest number of packets missing from a respective band compared to the ideal number of packets calculated for that band. That is, the TX queue is sorted so that there are 5 GHz with 7 packets (20 minus 7=13); 6 GHz with 8 packets (20 minus 8=12), and 2.4 GHz with 9 packets (10 minus 9=1).

Step 420 includes, for each band on the respective MLO station among the subscribing stations 307, determining whether the number of packets on the respective band is less than the ideal number of packets calculated for that band. If NO (step 422) check the next band for that MLO STA. If YES (step 424) calculate the number of packets missing from the ideal number of packets calculated for that band, divide by 2, and take packets evenly from a dual band queue combination that has that same band in it. For example the process goes through each band and sorts it as follows.

First, the process starts with the 5 GHz band. There are 7 packets for 5 GHz and the ideal number of packets is 20. Thus the process proceeds to calculate that 20-7 packets are missing, i.e., 13 packets. 13 divided by 2=6.5 rounded down to 6. Next, the process takes 6 packets from the dual band combination 2.4 GHz+5 GHz; 6 packets is the minimum between what is left in that group (7) and the even value of 6. Next, the process takes 6 packets from the dual band combination 5 GHz+6 GHz; 6 packets is the minimum between what is left in that group (6) and the even value of 6. Next the process (step 426) checks if there are missing packets, by checking the minimum value of (13-6−6)=1, and considering how many packets are actually left in the compatible group (2.4 GHz+5 GHz: 7-6=1; 5 GHz+6 GHz: 6-6=0). This result is 1; thus there is 1 missing packet. The process then takes 1 more packet in order for the transmission driver queue 312 that is still not handled and can be sent on the 5 GHz band; those can only come from the 2.4 GHz+5 GHz group.

Next the process continues with the 6 GHz band. There are 8 packets for the 6 GHz band and the ideal number of packets is 20. Thus the process proceeds to calculate that 20-8 packets are missing, i.e., 12 packets. 12 divided by 2=6. Next, the process (step 426) takes 6 packets from the group 2.4 GHz+6 GHz; 6 packets is the minimum between what is left in that group (13) and the even value of 6. Next, the process takes 0 packets from the group 5 GHz+6 GHz; 0 is the minimum between what is left in the group (0) and the even value of 6. Next the process (step 426) checks if there are missing packets, by checking the minimum value of (12−6−0)=6, and considering how many packets are actually left in the compatible group (2.4 GHz+6 GHz: 13−6=7; 5 GHz+6 GHz: 0−0=0). This result is 7; thus there are 6 missing packets. The process then takes 6 more packets in order for the transmission driver queue 312 that are still not handled and can be sent on the 6 GHz band; those can only come from the 2.4 GHz+6 GHz group.

Next the process continues with the 2.4 GHz band. There are 9 packets for the 2.4 GHz band and the ideal number of packets is 10. Thus the process proceeds to calculate that 10-9 packets are missing, i.e., 1 packet. 1 divided by 2=0.5 rounded down to 0. Next, the process takes 0 packets from the group 2.4 GHz+5 GHz; 0 packets is the minimum between what is left in that group (0) and the even value of 0. Next, the process takes 0 packets from the group 2.4 GHz+6 GHz; 0 packets is the minimum between what is left in that group (1) and the even value of 0. Next, the process (step 426) checks if there are missing packets, by checking the minimum value of (1-0−0)=1, and considering how many packets are actually left in the compatible group (2.4 GHz+5 GHz: 0-0=0; 2.4 GHz+6 GHz: 1-0=1). This result is 1, thus there is 1 missing packet. Take 1 more packet in order from the transmission driver queue 312 that is still not handled and can be sent in 6 GHz; those can only come from the 2.4 GHz+6 GHz group.

In step 428, the packets in the transmission driver queue are considered, and the process handles any non-handled STA that are left=0 packets.

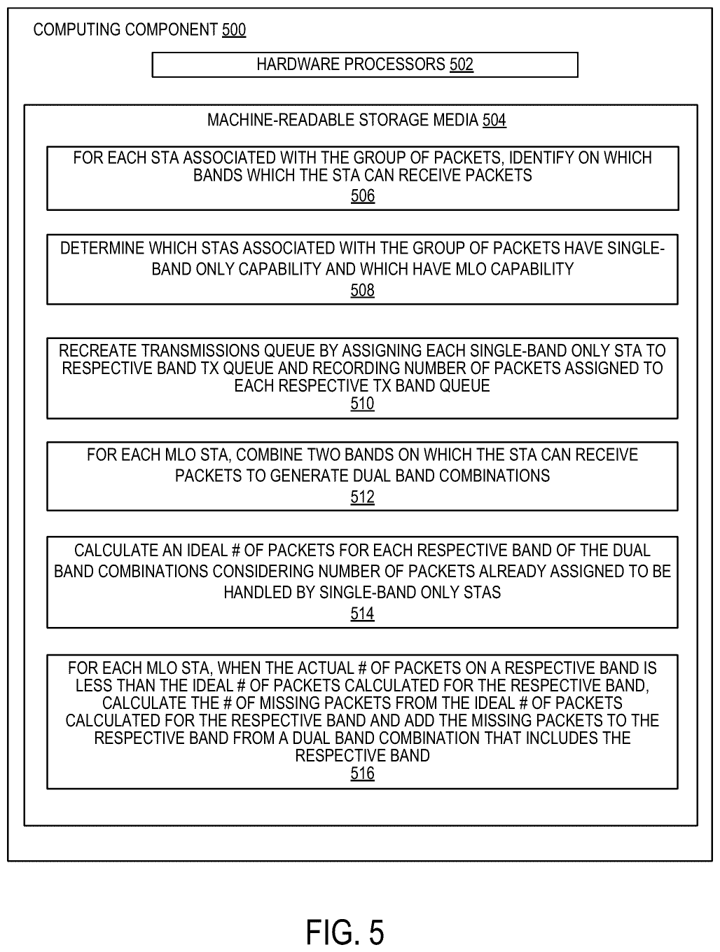

FIG. 5 is an example computing component 500 that may be used to implement various features of transmitting a group of packets from a network device or Access Point (AP) to one or more clients or stations (STAs) among a plurality of subscribing clients or stations (STA) according to an example of the present disclosure. The network device or AP may be, for example, APs 106a-c, 136, 146 as shown in FIG. 1 or AP 300 as shown in FIG. 3. The stations may be, for example, client devices 110a-j, 140a-d, 150a-b as shown in FIG. 1, or STA(s) 307 as shown in FIG. 3. Of course, these are just examples and the present disclosure is not limited thereto.

Computing component 500 may be, for example, a server computer, a controller, or any other similar computing component capable of processing data. Computing component 500 may be resident on the AP 300 or may be a server computer, controller, or other similar computing component external to but in communication with the AP 300. In the example implementation of FIG. 5, the computing component 500 includes a hardware processor 502 and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-516, to control processes or operations for implementing the various features of FIG. 5. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-518.

Hardware processor 502 may execute instruction 506 to, for each station associated with the group of packets, identify on which bands the station can receive packets, e.g., packets of the same flow as the group of packets with which the station is associated. In one example, the bands on which each station can receive packets can be identified using an association table such as the station association table 314, which may be located in the AP 300 or external thereto. As one example, the station association table 314 provides a reference listing of band(s) and corresponding stations, such that the AP 300 can access the table and look up matching band(s), or band(s) to which stations are associated, and so on.

Hardware processor 502 may execute instruction 508 to determine which stations associated with the group of packets have single-band only capability and which stations 307 have Multi-Link Operation (MLO) capability. This determination can also be done using an association table such as the station association table 314 that associates each station to either single-band capability or MLO capability.

Hardware processor 502 may execute instruction 510 to, for each station having only single-band capability, transmit packets in the group over a single band. A packet may be placed in the associated single band right away.

Instructions 512 to 516 are applied to each station having MLO capability. Specifically, hardware processor 502 may execute instruction 512 to combine two bands the station can receive on to generate TX dual band combinations. Dual band combinations may be identified/generated based on combinations of bands, e.g., 2.4 GHz+5 GHz, 2.4 GHz+6 GHz, 5 GHz+6 GHz.

Hardware processor 502 may execute instruction 514 to calculate an ideal number of packets for each respective band. For each band on which the station can receive packets, an ideal distribution value (e.g., an ideal percentage of weighted packet distribution per band) can be calculated based on the band's pre-calculated weight value. This can be done based on historical data or characteristics of the band such as band speed, channel width, signal-to-noise ratio (SNR), the average speed on the channels, etc. There may be more than one “ideal” number of packets depending on the factors and methodology used to calculate the ideal number. Moreover, as a person having ordinary skill in the art reading this document will recognize, a true or perfect “ideal” number cannot always be achieved; accordingly, an “ideal” number can include a number that is as good or effective as possible or practical under the given circumstances.

Hardware processor 502 may execute instruction 516 to, when the actual number of packets on a respective band is less than the ideal number of packets calculated for the respective band, calculate a number of missing packets from the ideal number of packets calculated for the respective band and add the missing packets to the respective band from one of the dual band combinations that includes the respective band. For example, a 2.4 GHz band can take from the group 2.4 GHz+5 GHz or from the group 2.4 GHz+6 GHz; a 5 GHz band can take from the group 2.4 GHz+5 GHz or from the group 5 GHz+6 GHz; a 6 GHz band can take from the group 2.4 GHz+6 GHz or from the group 5 GHz+6 GHz).

In more detail, instruction 516 includes, for each station with MLO capability that the group of packets is to be transmitted to, sorting the transmission bands for that station starting with the largest number of packets that are “missing” from a respective band compared to the ideal number of packets calculated for that band. For each transmission band on a station having MLO capability that the group of packets is to be transmitted to, instruction 516 checks whether the packet distribution (number of packets) on the respective band for that station is less than the ideal distribution (number of packets) calculated for that band. If the packet distribution on the respective band is not less than the ideal distribution calculated for that band then operation 516 proceeds to check the next band for that station (i.e., check whether the number of packets in the next band is less than the ideal number of packets calculated for that band). If the packet distribution on the respective band is less than the ideal distribution calculated for that band, then operation 516 proceeds to calculate the number of packets missing from the ideal number of packets calculated for that band (i.e., the number of packets below the ideal number), divide by two, and take packets evenly from a dual band queue combination that has that same band in it. In this way the missing packets are added to the respective band from one of the dual band combinations that includes the respective band. If a packet is still missing from that band then a packet is selected from the dual band queue combination for that station. For each station that the group of packets are transmitted to, the station is marked as handled. A count is kept of how many stations are left, i.e., how many stations remain that the group of packets must still be transmitted to. For any stations that are left (i.e., that the group of packets still must be transmitted to), instruction 516 assigns one of the bands from the dual band queue combination that the respective station is in. The actual choice is not critical or that important; the highest can be selected, or a random one, or a primary one, etc.

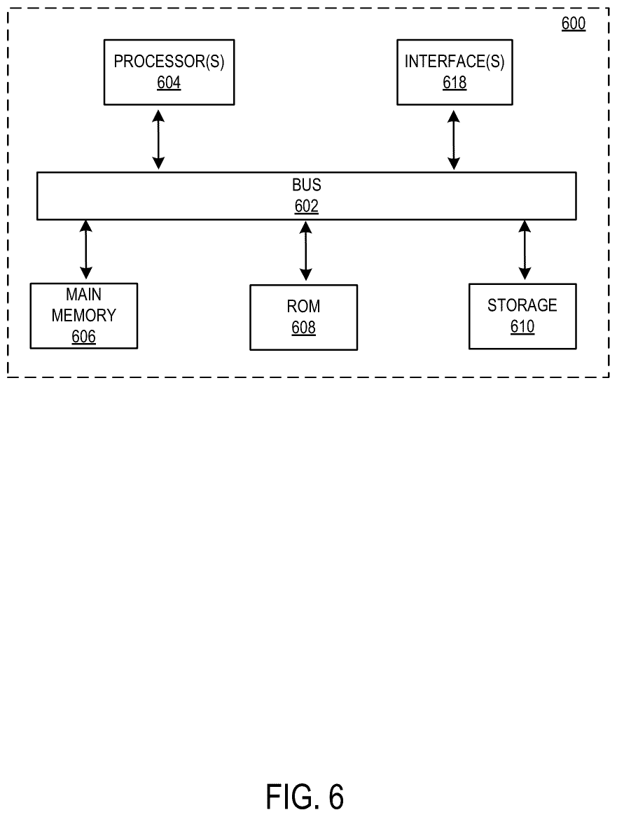

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 also includes a communication/network interface 618 coupled to bus 602. Communication interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN (or WAN component to communicated with a WAN). Wireless links may also be implemented. In any such implementation, communication interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media. The computer system 600 can send messages and receive data, including program code, through the network(s), network link and communication interface 618.

It should be noted that the terms “optimize,” “optimal” and the like as used herein can be used to mean making or achieving performance as effective or perfect as possible. However, as a person having ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
for each station associated with a group of packets to be transmitted, identifying on which bands each station can receive packets of the same flow as the group of packets to be transmitted;
determining which stations associated with the group of packets have single-band only capability and which stations have Multi-Link Operation (MLO) capability;
recreating a transmissions queue for each of the identified bands by:
for each station having single-band only capability, assigning each of the single-band only capable stations to a respective band transmission queue;
recording a number of packets assigned to each respective band transmission queue;
for each station having MLO capability, generate dual band combinations by combining two bands on which each MLO capable station can receive packets of the same flow as the group of packets to be transmitted;
calculating an ideal number of packets for each respective band of the dual band combinations considering a number of packets already assigned to be handled by the single-band only capable stations;
when an actual number of packets on a respective band is less than the ideal number of packets calculated for that respective band, calculating a number of missing packets from the ideal number of packets calculated for the respective band and adding the missing packets to the respective band from one of the dual band combinations that includes the respective band.

2. The method of claim 1, wherein the ideal number of packets for each respective band is based on at least one of band speed, channel width, channel availability, signal-to-noise ratio (SNR), or average speed on the channels.

3. The method of claim 1, wherein the respective bands are 2.4 GHz, 5 GHz, and 6 GHz, each of the respective bands being associated with one or more channels.

4. The method of claim 1, wherein determining which stations have single-band only capability and which stations have MLO capability includes accessing an association table to associate each station to either single-band capability or MLO capability.

5. The method of claim 4, wherein the association table is stored in the AP.

6. A method, comprising:
determining which stations of a plurality of subscribing stations have single-band only capability and which stations have Multi-Link Operation (MLO) capability;
recreating a transmissions queue for each band over which a group of packets is to be transmitted to at least one of the stations;
wherein each station having single-band only capability is assigned to a respective band transmission queue corresponding to a single band;
wherein each station having MLO capability is assigned to a respective dual band combination, each respective dual band combination comprising two bands on which each station having MLO capability is capable of receiving packets of the same flow as the group of packets to be transmitted;
calculating an ideal number of packets for each band of each dual band combination considering packets already assigned to be handled by the single-band only capable stations; and
when an actual number of packets on a respective band is less than the ideal number of packets calculated for that respective band, re-distributing the number of packets in each band so that the number of packets in each band corresponds to the ideal number of packets in the respective band.

7. The method of claim 6, wherein the ideal number of packets for each respective band is based on at least one of band speed, channel width, channel availability, signal-to-noise ratio (SNR), or average speed on the channels.

8. The method of claim 6, wherein the ideal number of packets comprises an ideal weighted distribution of packets per band.

9. The method of claim 6, wherein the respective bands are 2.4 GHz, 5 GHz, and 6 GHz, each of the respective bands being associated with one or more channels.

10. The method of claim 6, wherein the determining of which stations of a plurality of subscribing stations have single-band only capability and which stations have Multi-Link Operation (MLO) capability, and the recreating of the transmissions queue is performed by an access point (AP).

11. The method of claim 6, wherein determining which stations have only single-band capability and which stations have MLO capability includes accessing an association table to associate each station to either single-band capability or MLO capability.

12. The method of claim 11, wherein the association table is stored in the AP.

13. The method of claim 6, wherein the group of packets comprises unicast frames.

14. The method of claim 6, wherein the recreating of the transmissions queue further comprises sorting the bands over which the group of packets is to be transmitted in descending order according to numbers of missing packets from each of the respective bands.

15. A non-transitory machine-readable medium storing instructions that, when executed, causes at least one processor to operate a network device to:
for each station associated with a group of packets to be transmitted, identify on which bands the station can receive packets of the same flow as the group of packets to be transmitted;
determine which stations associated with the group of packets have single-band only capability and which stations have Multi-Link Operation (MLO) capability;
for each station having single-band only capability, assigning each of the single-band only capable stations to a respective band transmission queue;
for each station having MLO capability, generate dual band combinations by combining two bands on which each MLO capable station can receive packets of the same flow as the group of packets to be transmitted;
calculating an ideal number of packets for each respective band of the dual band combinations considering a number of packets already assigned to be handled by the single-band only capable stations;
when an actual number of packets on a respective band is less than the ideal number of packets calculated for that respective band, calculating a number of missing packets from the ideal number of packets calculated for the respective band and adding the missing packets to the respective band from one of the dual band combinations that includes the respective band.

16. The non-transitory machine-readable medium of claim 15, wherein the ideal number of packets for each respective band is based on at least one of band speed, channel width, channel availability, signal-to-noise ratio (SNR), or average speed on the channels.

17. The non-transitory machine-readable medium of claim 15, further comprising instructions causing the at least one processor to determine which stations have only single-band capability and which stations have MLO capability by accessing an association table to associate each station to either single-band capability or MLO capability.

18. The non-transitory machine-readable medium of claim 15, wherein the association table is stored in the network device.

19. The non-transitory machine-readable medium of claim 15, wherein the multiple bands are 2.4 GHz, 5 GHz, and 6 GHz.

20. The non-transitory machine-readable medium of claim 15, wherein the instructions further cause the at least one processor to sort the bands over which the group of packets is to be transmitted in descending order according to numbers of missing packets from each of the respective bands, and subsequently re-distribute the number of packets in each of the bands so that the number of packets in each band corresponds to the ideal number of packets in the respective band.
